(19) United States
(12) Patent Application Publication
(10) Pub. No.: US 2025/0305357 A1
(43) Pub. Date: Oct. 2, 2025

(54) RETRACTABLE SCREEN SYSTEM

(71) Applicant: The Smart Companies, LLC, Fort Myers, FL (US)

(72) Inventors: Robert BUTCHER, St. Charles, MI (US); Matt CLAUSEN, Fort Myers, FL (US); Janine WILSON, Fort Myers, FL (US)

(21) Appl. No.: 18/766,598

(22) Filed: Jul. 8, 2024

Related U.S. Application Data
(60) Provisional application No. 63/572,595, filed on Apr. 1, 2024.

(51) Int. Cl. E06B 9/42; E06B 9/00

(52) U.S. Cl. CPC E06B 9/42; E06B 2009/005

(57) ABSTRACT

A screen system is disclosed for use in protecting a building penetration. The screen system may include a first side rail having a first end and a second end, and a second side rail having a first end and a second end. The screen system may also include a screen having a first edge configured to slide along the first side rail, and an opposing second edge configured to slide along the second side rail. The screen system may further include a mounting track extending between the first ends of the first and second side rails, and at least one bracket moveable within the mounting track to any location along a length of the mounting track. The at least one bracket may be configured to operatively connect the screen to the mounting track.

### TECHNICAL FIELD

The present disclosure relates generally to a screen system and, more particularly, to a system having a retractable screen that protects against inclement weather.

### BACKGROUND

Storm screens (a.k.a., hurricane screens) are used to protect homes, schools, businesses, and other buildings from high winds, heavy rains, dust, and airborne debris. The screens come in different sizes and configurations that allow them to be deployed over a variety of building penetrations (e.g., windows, doors, entries, patios, alcoves, etc.). The screens can be deployed in anticipation of a storm and left in place until after the storm has receded. In some instances, the screens can also be used during pleasant weather, for example to reduce UV infiltration.

In conventional applications, the storm screen includes a primary surface made from a woven material, and reinforced sleeves that border the primary surface. The reinforced sleeves include cording that slides within channels affixed to sides of the protection area. In some instances, a motorized reel is mounted at a top end of the protection area and used to automatically furl and deploy the storm screen. An example of such a system is disclosed in U.S. Patent Application Publication 2011/0296774 (“the '774 publication”).

While conventional storm screens like those disclosed in the '774 publication may be adequate for some applications, they may still be less than optimal. For example, they may be available only in fixed sizes (e.g., fixed widths and/or lengths). This may increase a cost of each screen (e.g., when a wider and/or longer screen than required is used), and require a large inventory of different products that an installer must keep on hand. The fixed sizing may also increase an assembly difficulty and time required when the size of the screen does not appropriately match the size of the penetration.

The disclosed screen system is directed at addressing one or more of these issues discussed above and/or other problems of the prior art.

### SUMMARY

In one aspect, the present disclosure is directed to a screen system. The screen system may include a first side rail having a first end and a second end, and a second side rail having a first end and a second end. The screen system may also include a screen having a first edge configured to slide along the first side rail, and an opposing second edge configured to slide along the second side rail. The screen system may further include a mounting track extending between the first ends of the first and second side rails, and at least one bracket moveable within the mounting track to any location along a length of the mounting track. The at least one bracket may be configured to operatively connect the screen to the mounting track.

In another aspect, the present disclosure is directed to another screen system. This screen system may include a first side rail having a first end and a second end, and a second side rail having a first end and a second end. The screen system may also include a spindle and a screen. The screen may include a first edge configured to slide along the first side rail, an opposing second edge configured to slide along the second side rail, and a third edge that extends between the first and second edges and is connected to the spindle along an axial length of the spindle. The screen system may further include a first spindle support rotationally connected to a first end of the spindle and having a pattern of mounting features, a second spindle support rotationally connected to an opposing second end of the spindle and having a pattern of mounting features, and a mounting track extending between the first ends of the first and second side rails. The screen system may additionally include first and second brackets slidably received within a cradle of the mounting track. The pattern of mounting features may be repeated multiple times within each of the first and second brackets at different locations corresponding to different lengths of the screen.

In yet another aspect, the present disclosure is directed to a bracket for a screen system. The bracket may include a first platelike portion, a second platelike portion oriented orthogonally relative to the first platelike portion, and a neck connecting the first and second platelike portions. The second platelike portion may include a repeated pattern of mounting features, and the patterns may be spaced apart from other each along a line.

### BRIEF DESCRIPTION OF THE DRAWINGS

FIGS. 1 and 2 are diagrammatic illustrations of an exemplary disclosed screen system;

FIGS. 3, 4, and 5 are cross-sectional and diagrammatic illustrations of exemplary portions of the screen system of FIGS. 1 and 2;

FIG. 6 is another diagrammatic illustration of the screen system of FIG. 1, with an exemplary front cover and endcap removed for clarity;

FIG. 7 is a cross-sectional illustration of the screen system of FIGS. 1, 2 and 6;

FIGS. 8, 9, and 10 are an enlarged diagrammatic illustrations of exemplary portions of the screen system of FIGS. 1, 2, 6 and 7; and

FIG. 11 is a diagrammatic illustration of an exemplary alternative embodiment of a portion of the screen system of FIGS. 1, 2, 6 and 7.

### DETAILED DESCRIPTION

The term “about” as used herein serves to reasonably encompass or describe minor variations in numerical values measured by instrumental analysis or as a result of sample handling. Such minor variations may be considered to be “within engineering tolerances” and in the order of plus or minus 0% to 10%, plus or minus 0% to 5%, or plus or minus 0% to 1% of the numerical values.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

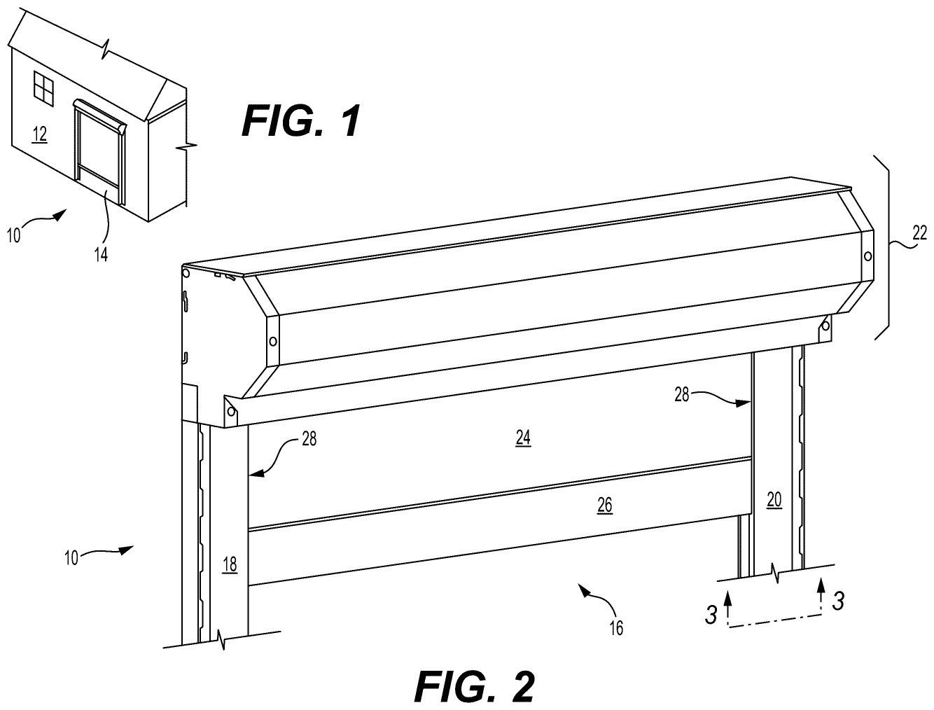

FIG. 1 illustrates a screen system 10 affixed to a building 12 at a penetration opening 14. In the disclosed embodiment, opening 14 is an entryway to building 12. It is contemplated, however, that opening 14 could alternatively be associated with a window, a patio, a door, an alcove, or any other type of penetration. In general, screen system 10 may substantially surround opening 14 on at least three sides (e.g., a left side, a top side, and a right side), while also extending across a space between the sides. In some embodiments, screen system 10 may surround opening 14 on four sides (e.g., the left side, the top side, the right side, and a bottom side). Although not shown, a spacer (e.g., a three- or four-sided picture frame type of spacer) may be placed around opening 14 and between building 12 and screen system 10 to space screen system 10 a desired distance away from a window or door inside the space.

As shown in FIG. 2, screen system 10 may be an assembly of multiple components that cooperate to protect opening 14 (and/or the window or door inside opening 14) from wind, rain, dust, debris, sand, UV light, etc. These components may include, among other things, a screen 16, a left-side rail 18, a right-side rail 20, and a hood 22 that extends transversely between upper ends of rails 18, 20. As will be explained in more detail below, screen 16 may be moveably connected to building 12 via rails 18, 20 and selectively furled or unfurled from within hood 22.

Screen 16 may be a sewn fabrication including, among other things, a flexible primary surface 24, a rigid lower edge 26, and one or more guides 28 located at the left- and right-sides (i.e., left and right relative to the perspective of FIG. 2) of primary surface 24. In one example, primary surface 24 is woven from a polymer fabric (e.g., a polypropylene monofilament) using a basket weave design. It is contemplated, however, that non-polymer fabrics and/or other weave designs may be utilized to form primary surface 24, if desired. Edge 26 may extend transversely between guides 28 at the lower (e.g., lower relative to gravity) edge of primary surface 24. Each of edge 26 and guides 28 may be attached to primary surface 24 via hemming (e.g., via folding and stitching) in any conventional manner (e.g., bi-fold hemming, tri-fold hemming, etc.).

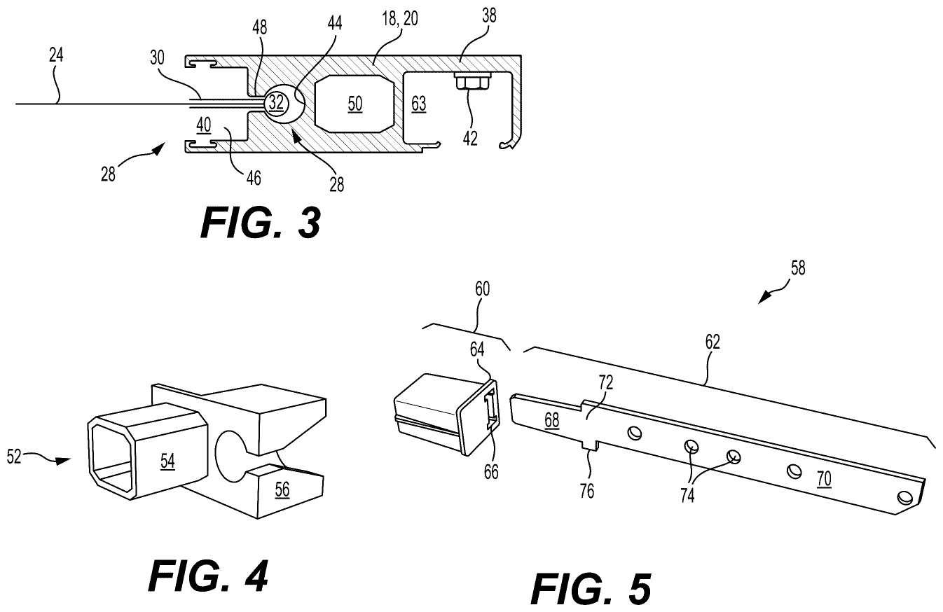

As shown in FIG. 3, each guide 28 may be formed from an elongated ribbon or tape 30 having integral cording 32 (e.g., nylon, PVC, metallic, and/or natural cording) extending along a lengthwise edge of tape 30. Guides 28 may be sewn or otherwise attached to primary surface 24, such that cording 32 of each guide 28 is located at an outer most side-edge of primary surface 24 (i.e., such that cordings 32 are oriented away from each other).

Rails 18, 20 may have substantially identical geometry, but be mirrored relative to each other in the assembly of screen system 10. For example, as shown in the cross-section of FIG. 3, each or rails 18, 20 may include a mounting flange 38 that protrudes outward away from primary surface 24, and a slide channel 40 located at an opposite side. One or more fasteners 42 may pass through flange 38 (e.g., through apertures formed in flange 38) and into a structural member (not shown) of building 12 (referring to FIG. 1). Any number of fasteners 42 may be spaced apart along a length of rails 18, 20 to appropriately secure screen system 10 in place.

Slide channel 40 may include one or more openings that are oriented inward toward primary surface 24. For example, slide channel 40 may include an elongated inner recess 44 inset within the floor of an elongated outer recess 46. Inner recess 44 may have a cross-sectional shape that compliments the cross-sectional shape of cording 32 (e.g., inner recess 44 may be bulbous), such that cording 32 is captured therein. With this configuration, cording 32 may be inhibited from being pulled out in a direction orthogonal to an axis of inner recess 44, yet still capable of relative sliding motion in a vertical or axial direction of channel 40. Outer recess 46 may have a cross-sectional shape that compliments a profile of edge 26 (e.g., outer recess 46 may be rectangular), such that an end of edge 26 is received therein and capable of relative sliding motion in the vertical or axial direction. In the disclosed embodiment, outer recess 46 has a larger cross-sectional area than inner recess 44; although this may not always be true. An open neck 48 may connect inner recess 44 to outer recess 46 and provide clearance for tape 30 that joins cording 32 to primary surface 24.

An alignment opening 50 may be formed within each of rails 18, 20 and located transversely between flange 38 and slide channel 40. Opening 50 may be configured (e.g., located, shaped, and/or sized) to receive (e.g., via an interference fit) an alignment bushing 52 at an upper end (i.e., the end closest to hood 22) of each of rails 18, 20. As shown in FIG. 4, bushing 52 may include a stem 54 that extends into opening 50, and a slotted funnel 56 that protrudes away from stem 54 in an opposing direction. Funnel 56 may be axially offset from stem 54, such that a central axis of funnel 56 is generally aligned with a central axis of inner recess 44. With this configuration, funnel 56 may be configured to direct cording 32 from hood 22 into inner recess 44. Sidewalls of funnel 56 may help to protect screen 16 from sharp edges at the ends of rails 18 and 20, while the slotted portion of funnel 56 may provide clearance for tape 30.

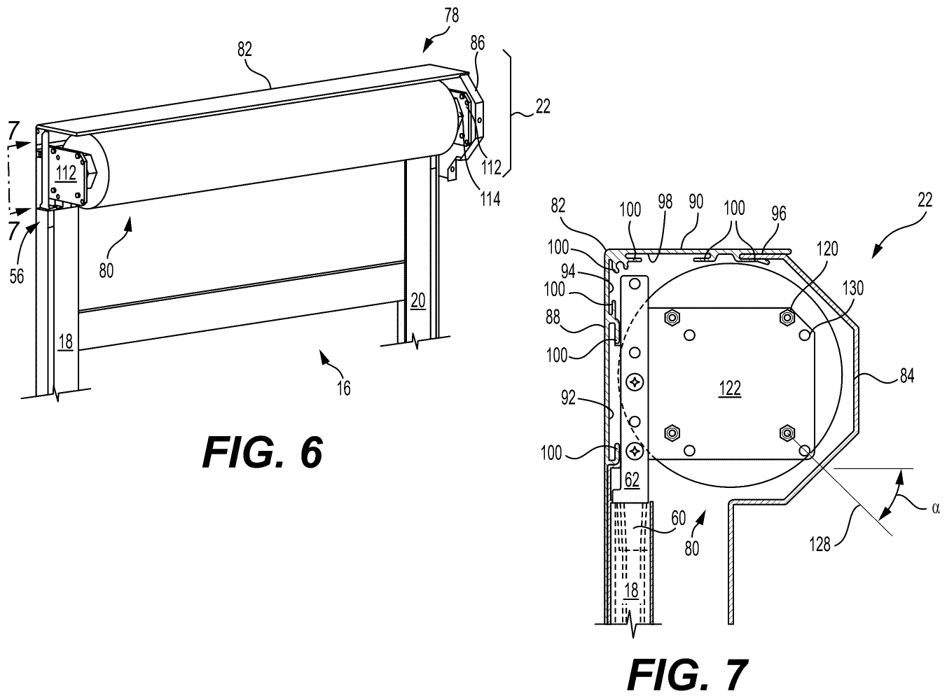

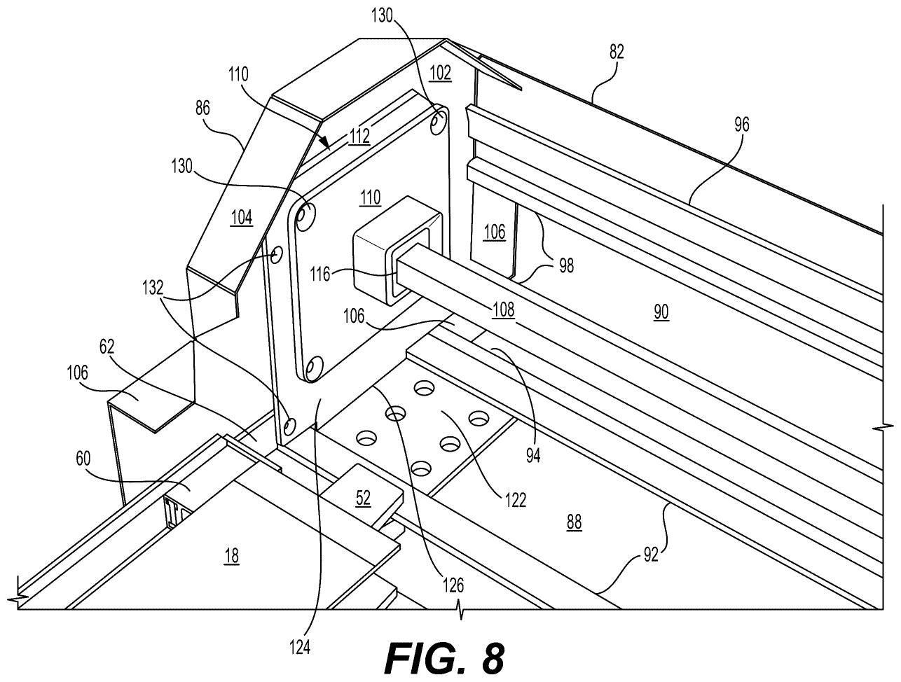

As will be explained in more detail below, an adapter 58 may be used to align and connect the upper end of each of rails 18, 20 to a corresponding left- or right-side of hood 22 (referring to FIGS. 6 and 7). An example adapter 58 is shown in detail in FIG. 5. Adapter 58 may include, among other things, a boot 60 and a leg bracket 62 that is at least partially received within boot 60. While boot 60 and leg bracket 62 are shown in this embodiment as being separate components, it is contemplated that boot 60 and leg bracket 62 could be combined into an integral monolithic component, if desired.

Boot 60, like stem 54, may be inserted into a corresponding opening 63 formed in the upper end of each rail 18, 20 (e.g., formed at the end of mounting flange 38). Boot 60 may have a generally cuboid shape that tapers from an upper external surface toward a lower internal surface to facilitate assembly into rails 18, 20 (e.g., via an interference fit). A horizontal flange 64 may be formed at the upper surface to limit an insertion depth of boot 60, and a slot 66 may be formed at one side of boot 60 (e.g., near an outer edge, relative to primary surface 24) to pass from the upper end surface through the opposing lower end surface of boot 60. A width of slot 66 may extend in a depth direction of screen system 10.

Leg bracket 62 may be elongated (i.e., have a length greater than a width) and thin (i.e., have a thickness less than the width), and include a foot 68 at a first end that is configured to extend into slot 66, a mount 70 that protrudes away from foot 68 towards a second end, and a knee 72 that connects foot 68 to mount 70 at location between the first and second ends. Mount 70 may include a plurality of mounting features 74 (e.g., perforations passing through leg bracket 62 in the thickness direction) spaced apart along its length and be transversely offset or staggered in a width direction from foot 68. A depth limiter 76 may extend from knee 72 in the width direction to mate against the upper end surface of boot 60 (e.g., at flange 64) and thereby limit an insertion depth into boot 60.

An exemplary hood 22 is illustrated in FIGS. 6, 7, and 8. As can be seen from these images, hood 22 may be an assembly of multiple components that cooperate to enclose, protect, and deploy screen 16. These components may include, among other things, a housing 78 and a reel assembly 80 disposed inside of housing 78.

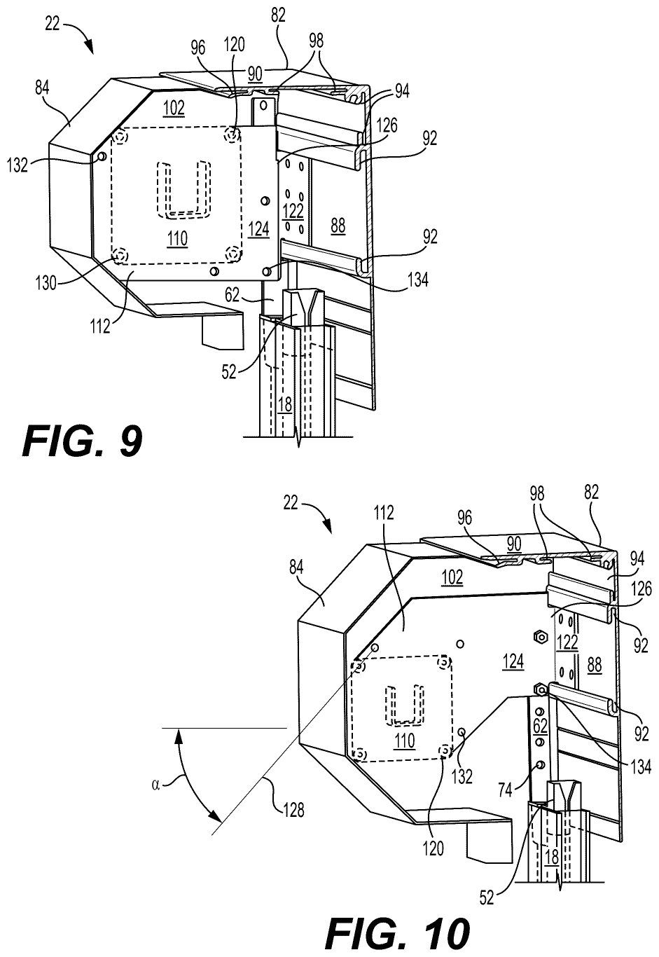

Housing 78 may include an elongated mounting track 82, a similarly elongated front cover 84 (removed from FIGS. 6 and 8 for clarity), and opposing endcaps 86 (right endcap 86 shown in FIG. 6; left endcap 86 shown in FIG. 8). As will be illustrated in the cross-section of FIG. 7, a lengthwise edge of front cover 84 may be configured to interlock with a corresponding lengthwise edge of track 82 and together form a substantially closed cylindrical volume. A longitudinal slot may remain open at a lower side of housing 78 and to allow screen 16 to slide in/out of housing 78. Endcaps 86 may engage track 82 and front cover 84 at opposing ends to axially bound the cylindrical volume.

Track 82 may be generally L-shaped, having aback portion 88 configured to mate against building 12, and an integral top portion 90 that extends orthogonally away from building 12 over reel assembly 80. Back portion 88 may be generally wider than top portion 90, and both of back and top portions 88, 90 may include a plurality of integral attachment features extending into the enclosure of housing 78. For example, back portion 88 may include a reel cradle 92 and a cap receiver 94, while top portion 90 may include a cover receiver 96 and a cap receiver 98. Each of reel cradle 92 and cap receivers 94, 98 may be formed from paired prongs 100 (labeled only in FIG. 7 for clarity) that extend away from a planar surface of the corresponding back or top portions 88, 90 inwards towards each other. With this configuration, an undercut region may be created between each prong pairing and the surface. Tips of prongs 100 may be spaced apart from each other, such that corresponding tabs (explained in more detail below) of mating components may be inserted into the undercut regions from only an end of track 82 and can't be pulled out transversely. Cover receiver 96 may be formed in similar manner, but includes only a single prong 100.

It should be noted that a cross-section of track 82 may be substantially identical along its entire length. This may allow for track 82 to be cut at any distance along its length (e.g., to fit any width of opening 14) and still have all features at each end necessary for attachment to the mating components. A plurality of fasteners (not shown) may be selectively passed through corresponding apertures spaced along the length direction of back portion 88 to secure track 82 to the structural members of building 12. It should be noted that, in some embodiments, the fasteners could additionally or alternatively pass through corresponding apertures formed in top portion 90 (e.g., when screen system 10 is installed within opening 14 instead of against building 12 over opening 14), if desired.

As shown in FIG. 7, front cover 84 may have a cross-section with a general C-shape (e.g., a smooth curved or segmented shape) or the shape of a question mark (e.g., a C-shape with a leg extending downward from a lower end of the C-shape). These shapes, together with the L-shaped cross-section of track 82, may function to annularly enclose reel assembly 80. An upper lengthwise edge of the C-shape may be received within (e.g., pressed into) the undercut region of cover receiver 96 described above. In some applications, during the pressing of this edge into the undercut region, the corresponding prong 100 may flex somewhat to apply a pressure against the edge that helps retain the edge in place. In the front cover embodiment having the question mark shape, the leg may extend downward in a direction generally parallel with rails 18, 20, such that the elongated open slot is formed between the leg and back portion 88 of track 82. It is contemplated that one more fasteners (not shown) may be passed through track 82 and front cover 84 (e.g., along the engaged edge) for additional security, if desired.

As shown in FIG. 7, Endcaps 86 may be available in two different configurations (i.e., a left-hand configuration and a right-hand configuration). The different configurations may be substantially identical to each other, but mirrored to mate with opposing ends of track 82 and front cover 84. As shown in FIG. 8, each endcap 86 may have a generally planar end surface 102 with an outline that matches a cross-section of the annular enclosure formed by track 82 and front cover 84. A border 104 may extend from end surface 102 inward (e.g., toward screen 16) in a direction generally orthogonal to end surface 102, and any number of tabs 106 may protrude from end surface 102 for insertion into cap receivers 94, 98. In the disclosed embodiment, border 104 is segmented to match the combined and segmented shape of track 82 and front cover 84 and configured to overlap with ends thereof. In another embodiment (not shown), border 104 is smooth and continuous. Tabs 106 may be inserted into the undercut regions of cap receivers 94, 98 and, as explained above, the corresponding prongs 100 may flex to exert a retention force on tabs 106. One or more fasteners may be passed through border 104 and overlapping portions of front cover 84 to help secure these components together.

As shown in FIGS. 6 and 8, reel assembly 80 may include components that cooperate to reel screen 16 into and out of housing 78 (e.g., through the elongated open slot described above). These components may include among other things, a spindle 108, one or more (e.g., two) spindle supports 110, and one or more (e.g., two) track attachment brackets 112. In some embodiments, a motor (e.g., an electric motor—shown only in FIG. 6) 114 may additionally be associated with spindle 108 to provide for automated operation of reel assembly 80.

An upper edge of screen 16 may be connected to spindle 108 along an axial length of spindle 108. With this configuration, a rotation of spindle 108 in a first direction may result in reeling in of screen 16, and a rotation in a second opposite direction may result in reeling out of screen 16. Each spindle support 110 may support one-half of the combined weight of spindle 108 and screen 16 via a bearing 116. Spindle support 110 may be removably affixed to a corresponding one of brackets 112 via any number of fasteners 120. Motor 114, if present, may be positioned between the corresponding end of spindle 108 and support 110.

Exemplary track attachment brackets 112 are shown in FIGS. 9 and 10, with spindle support 110 overlaid in phantom. Each bracket 112 may be generally L-shaped, having a track engagement portion 122 and a spindle engagement portion 124 that are connected to each other via a neck 126. Portion 122 may be oriented generally parallel to back portion 88 of track 82 when assembled, while spindle engagement portion 124 may lie generally parallel to end surface 102 of endcap 86 (i.e., portions 122 and 124 may be generally orthogonal to each other). An area of portion 122 may be smaller than an area of portion 124, and portion 122 may be configured for insertion from an end of track 82 into the undercut regions of reel cradle 92. During assembly, brackets 112 may be slid into the corresponding undercut regions to any axial location along the length of track 82, and prongs 100 of reel cradle 92 may flex to provide a retention pressure against portion 122. In some embodiments, one or more fasteners may be passed through apertures in portion 122 and back portion 88 of track 82 for additional security.

Spindle engagement portion 124 may be configured as a mount for spindle support 110 in multiple (e.g., two or more) different positions corresponding to lengths of different screens 16 and/or different diameters of screen 16 once reeled onto spindle 108 (removed from FIGS. 9 and 10, for clarity). FIG. 9 illustrates spindle support 110 mounted in a small-reel (i.e., short-screen) configuration, while FIG. 10 illustrates spindle support 110 mounted in a large-reel (i.e., large-screen) configuration. When in the small-reel configuration, spindle support 110 may be located closer to back and/or top portions 88, 90 of track 82. When in the large-reel configuration, spindle support 110 may be located further from back and/or top portions 88, 90. In the disclosed embodiment, spindle support 110 may move between the small- and large-reel mounting configurations along a line 128 that is oriented at an oblique angle α relative to back and/or top portions 88, 90. In some applications, α may be about 35-55° (e.g., about 45°).

In FIG. 9, Spindle support 110 may mount to spindle engagement portion 124 of bracket 112 via a plurality of mating attachment features. In the disclosed example, these features include apertures 130 formed in spindle support 110 that generally align with corresponding apertures 132 formed in bracket 112. In this example, spindle support 110 is generally rectangular, and includes one aperture 130 located at each corner to form a rectangular pattern of apertures 130. The same rectangular pattern may be formed with apertures 132 in bracket 112 and repeated multiple times at different locations along line 128 for any number of discrete mounting locations. It should be noted, however, that spindle support 110 and the corresponding pattern of apertures 130 (or other types of attachment features) could have a different shape (triangular, circular, etc.), if desired. Any number of fasteners may pass through aligned apertures 130, 132 and be used to secure spindle support 110 to bracket 112.

Bracket 112 of FIG. 9 may have a different shape and/or series of patterns than bracket 112 of FIG. 10. For example, spindle engagement portion 124 of the FIG. 9—embodiment may be generally symmetrical about and/or vertically centered relative to track engagement portion 122, while spindle engagement portion 124 may be asymmetrical and/or offset vertically downward in the FIG. 10—embodiment. In addition, spindle engagement portion 124 of FIG. 10 may extend further away from back portion 88 and/or top portion 90 of track 82. These differences may allow for bracket 112 of FIG. 10 to be used with a different range of screen sizes (e.g., screens that are larger than can be accommodated with bracket 112 of FIG. 9). In addition, while spindle engagement portion 124 may be generally rectangular (albeit with a chamfered upper-outer corner—see FIG. 7) in the FIG. 9—embodiment, spindle engagement portion 124 may have a trapezoidal shape (e.g., a rectangular shape with two chamfered corners, including opposing upper-outer and lower-inner corners). In both embodiments, the chamfered edge(s) may generally parallel with line 128.

As shown in FIGS. 9 and 10, brackets 112 may additionally be used to align and connect rails 18, 20 to hood 22. For example, mount 70 of leg bracket 62 may extend upward along an inner edge of spindle engagement portion 124 (e.g., at a side opposite spindle support 110). Spindle engagement portion 124 may include one or more (e.g., two) apertures 134 formed along the inner edge that are configured to align with corresponding mounting features 74 spaced apart along the length of mount 70. With this configuration, regardless of an exact length of rails 18, 20 and/or opening 14, adapter 58 may still be used to transversely align rails 18, 20 with the ends of hood 22 and to connect rails simultaneously vertically 18, 20 to back portion 88 of track 82. This may allow for rails 18, 20 to be used with penetration openings 14 having a range of different vertical lengths. This may reduce a need for custom sized rails, while also reducing a need for installers to maintain large inventories.

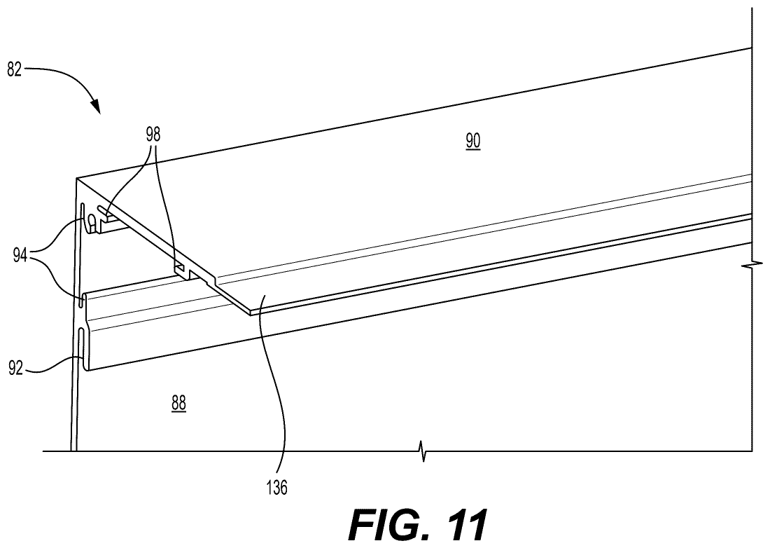

FIG. 11 illustrates an alternative embodiment of track 82. Like track 82 shown in FIGS. 7-10, track 82 of FIG. 11 may be L-shaped and include top portion 90 extending away from back portion 88 in a generally orthogonal orientation. In addition, track 82 of FIG. 11 may include reel cradle 92 and cap receivers 94, 98 that are substantially identical to those shown in FIGS. 7-10. However, in contrast to the embodiment shown in FIGS. 7-10, track 82 of FIG. 11 may include a different cover receiver 136. For example, cover receiver 136 may have a male-type attachment feature configured to be received within a corresponding female-type feature (not shown) formed along the upper lengthwise edge of front cover 84. In this example, the female-type feature may be substantially identical to the attachment feature of cover receiver 96 shown in the embodiment of FIGS. 7-10, while the male-type feature of cover receiver 136 may be a generally planar protrusion. In some applications, the male-type feature may be parallel with, but stepped down from primary surface of top portion 90. It has been found that this configuration may make it easier to align front cover 84 with track 82 during installation, and also increase a strength and/or rigidity of hood 22.

### INDUSTRIAL APPLICABILITY

The disclosed screen system may be used to protect a variety building penetrations from inclement weather. In addition, the disclosed screen system may provide installation flexibility to accommodate a wide range of penetration sizing in an efficient manner.

The design of hood 22, together with an exemplary disclosed fabrication process, may provide flexibility in accommodating varying widths of openings 14. For example, because track 82 may have a consistent cross-sectional shape along its entire length, track 82 may be cut to any length required to properly fit the width of penetration opening 14 and still provide all required features and functionality. This may allow for track 82 to be provided to the installer as a continuous stock material, rather than being fabricated and inventoried in only a handful of discrete sizes. In addition, the consistent cross-sectional shape of track 82 may be fabricated via low-cost processes, such as via extrusion from a corrosion resistant material (e.g., aluminum).

Front cover 84, like track 82, may also have a consistent cross-sectional shape along its length. In some applications, this may allow front cover 84 to also be extruded. However, because of the simplified geometry of front cover 84, an even more efficient method of fabrication (e.g., stamping or stamp-forming) may be possible. Front cover 84 may be fabricated from the same material (e.g., aluminum) as track 82, or fabricated from a different material (e.g., a less expensive material, such as steel or a steel alloy). It is contemplated that other components of system 10 (e.g., endcaps 86) may also be formed from aluminum, steel, or a steel alloy via stamping, if desired.

The design of rails 18, 20, along with an exemplary disclosed fabrication process, may provide flexibility in accommodating varying lengths of penetration openings 14. For example, because rails 18, 20 may have a consistent cross-sectional shape along their entire lengths, rails 18, 20 may also be cut to any length required to properly fit the length of penetration opening 14 and still provide all required features and functionality. This, along with the mirrored geometry of the two rails, may allow for rails 18, 20 to be provided to the installer as a single continuous stock material. In addition, the consistent cross-sectional shape of rails 18, 20 may be fabricated via low-cost processes, such as via extrusion from a corrosion resistant material (e.g., aluminum).

In addition, the way in which rails 18, 20 connect to hood 22 may allow for length variability in penetration openings 14 and/or minor length adjustments to be made on site (e.g., without requiring changes to or different rails 18, 20). For example, rails 18, 20 may be selectively shifted up or down relative to penetration opening 14 and still be properly aligned with hood 22 via adapter 58. That is, different combinations of mounting features 74 may be used to connect rails 18, 20 to track 82 via bracket 112—each combination providing a different vertical placement of rails 18, 20.

As described above, brackets 112 be configured to accommodate screens 16 having a range of different lengths and corresponding diameters when reeled onto spindle 108. This may allow for a reduced inventory and/or a higher volume of parts, which can result in lower costs.

It will be apparent to those skilled in the art that various modifications and variations can be made to the disclosed screen system. Other embodiments will be apparent to those skilled in the art from consideration of the specification and practice of the disclosed screen system. It is intended that the specification and examples be considered as exemplary only, with a true scope being indicated by the following claims and their equivalents.

What is claimed is:

1. A screen system, comprising:
a first side rail having a first end and a second end;
a second side rail having a first end and a second end;
a screen having a first edge configured to slide along the first side rail, and an opposing second edge configured to slide along the second side rail;
a mounting track extending between the first ends of the first and second side rails; and
at least one bracket moveable within the mounting track to any location along a length of the mounting track and configured to operatively connect the screen to the mounting track.

2. The screen system of claim 1, wherein:
the screen system further includes a spindle;
the screen includes a third edge extending between the first and second edges, the third edge being attached to the spindle along an axial length of the spindle; and
the at least one bracket includes:
a first bracket connecting a first end of the spindle to the mounting track; and
a second bracket connecting a second end of the spindle to the mounting track.

3. The screen system of claim 2, wherein each of the first and second brackets includes a plurality of discrete mounting locations for the spindle.

4. The screen system of claim 3, wherein each of the plurality of discrete mounting locations corresponds with a different length of the screen.

5. The screen system of claim 3, wherein the plurality of discrete mounting locations are spaced apart from each other along a line that is oriented obliquely relative to the mounting track.

6. The screen system of claim 5, wherein an angle between the line and the mounting track is about 35-55°.

7. The screen system of claim 6, wherein the angle is about 45°.

8. The screen system of claim 3, further including:
a first spindle support rotationally connecting the first end of the spindle to the first bracket; and
a second spindle support rotationally connecting the second end of the spindle to the second bracket.

9. The screen system of claim 8, wherein:
each of the first and second spindle supports includes a pattern of mounting features; and
the pattern of mounting features is repeated multiple times within each of the first and second brackets.

10. The screen system of claim 9, wherein the repeated patterns of mounting features are spaced apart along a line that is oriented obliquely relative to the mounting track.

11. The screen system of claim 1, wherein the at least one bracket is generally L-shaped.

12. The screen system of claim 1, wherein the at least one bracket includes:
a first platelike portion oriented generally parallel with the mounting track after assembly; and
a second platelike portion that extends orthogonally from an edge of the first platelike portion.

13. The screen system of claim 12, wherein:
the first platelike portion is slidingly received within a cradle formed in the mounting track; and
the second platelike portion is operatively connected to the screen.

14. The screen system of claim 1, further including:
a first alignment bushing connected to the first end of the first side rail and configured to guide the first edge into a slide channel of the first side rail; and
a second alignment bushing connected to the first end of the second side rail and configured to guide the opposing second edge into a slide channel of the second side rail.

15. The screen system of claim 14, wherein each of the first and second alignment bushings includes:
a stem inserted into an opening of the associated one of the first and second rails; and
a slotted funnel axially offset from the stem and aligned with the slide channel.

16. The screen system of claim 1, wherein the first and second rails are substantially identical and assembled in mirrored opposition to each other.

17. A screen system, comprising:
a first side rail having a first end and a second end;
a second side rail having a first end and a second end;
a spindle;
a screen having a first edge configured to slide along the first side rail, an opposing second edge configured to slide along the second side rail, and a third edge that extends between the first and second edges and is connected to the spindle along an axial length of the spindle;
a first spindle support rotationally connected to a first end of the spindle and having a pattern of mounting features;
a second spindle support rotationally connected to an opposing second end of the spindle and having a pattern of mounting features;
a mounting track extending between the first ends of the first and second side rails;
a first bracket slidably received within a cradle of the mounting track, wherein the pattern of mounting features is repeated multiple times within the first bracket at different locations corresponding to different lengths of the screen; and
a second bracket slidably received within the cradle of the mounting track, wherein the pattern of mounting features is repeated multiple times within the second bracket at different locations corresponding to different lengths of the screen.

18. A bracket for a screen system, the bracket comprising:
a first platelike portion;
a second platelike portion oriented orthogonally relative to the first platelike portion; and
a neck connecting the first and second platelike portions,
wherein:
the second platelike portion includes a repeated pattern of mounting features; and
the patterns are spaced apart from other each along a line.

19. The bracket of claim 18, wherein:
the mounting features are holes; and
the line is oriented at an oblique angle relative to a planar surface of the first platelike portion.

20. The bracket of claim 19, wherein the oblique angle is about 35-55°.
